(19) United States
(12) Patent Application Publication
(10) Pub. No.: US 2005/0145345 A1
(43) Pub. Date: Jul. 7, 2005

(54) Pulley anchor dock for a shutter cord

(76) Inventor: Chin-Fu Chen, Changhua Hsien (TW)

Correspondence Address: BIRCH STEWART KOLASCH & BIRCH, PO BOX 747, FALLS CHURCH, VA, 22040-0747, US

(21) Appl. No.: 10/751,416

(22) Filed: Jan. 6, 2004

(51) Int. Cl. E06B 9/30

(52) U.S. Cl. 160/173 R

(57) ABSTRACT

A pulley anchor dock for a shutter cord made from plastic and formed substantially as a U-shaped dock in an integrated manner. The dock has a bottom plate and a side plate located respectively on a left side and a right side thereof. The bottom plate holds a closed fort-like holding seat in the center that is extended upwards. The holding seat has at least two interdental spaces corresponding to each other in vertically to form a plurality of holding troughs. The corresponding holding troughs on the upper side and the lower side can jointly hold an axle of a pulley. The pulley allows a shutter cord to wind thereon to control lifting and lowering of a shutter.

### FIELD OF THE INVENTION

The present invention relates to a shutter component and more particularly to a pulley anchor dock for a shutter cord that is simple to fabricate and easy to assemble and install.

### BACKGROUND OF THE INVENTION

Conventional shutters (referring to FIG. 1) usually have pulley docks 2 mounted respectively at suitable locations on two sides of a square bracket 1 on an upper edge. The pulley dock 2 is made of metal by stamping. It has a wedge flange 3 on an upper end to wedge in a trough 4 of the bracket 1, and a punched hole 5 on a lower end to rivet with a hole on the bottom end of the bracket 1 so that the pulley dock 2 may be fastened securely on the bracket 1. There are side plates 6 on two sides of the pulley dock 2 that have respectively a pivot hole 7 to hold a fastening device (not shown in the drawing) which has an axle in the center. The pulley dock 2 has a bottom plate A which holds a pulley pivot seat 8. The pulley pivot seat 8 has two opposing apertures 9 to hold the axle extending from two sides of a sheave 10. A shutter cord B for lifting and lowering shutter slats threads through a hole 11 formed on the side plate 6, passes over the sheave 10 and threads through the hole formed on the bottom plate A to fasten to the shutter slats. When the cord B is pulled to lower the shutter slats it can slide on the sheave 10 to reduce friction.

Conventional pulleys are made by stamping a steel sheet; the fabrication process is complicated and time-consuming. Moreover, the punch hole 5 on the bottom plate A of the pulley dock 2 is fixed on the bottom end of the bracket 1 by riveting, assembly is inconvenient. In addition, the pulley dock 2 is located on the shutter where the cord B lifts or lowers the shutter slats, it has to be pivotally coupled on a set of pivotal holes 7 on the pulley dock 2 to enable the cord B to pass over the sheave 10 and run through the hole in the center of the bottom plate A to fasten the shutter slats. However, due to the conventional approach, the axle of the sheave 10 pivotally coupled on the apertures 9, assembly is inflexible, and has to be fabricated respectively to pivotally couple the left side and right sides of the pulley dock 2 in two different directions. This results in increase of inventory.

### SUMMARY OF THE INVENTION

Therefore the primary object of the invention is to provide a pulley anchor dock for a shutter cord that is made in an integrated manner. It includes a U-shaped dock. The dock has a bottom plate holding a fort-like closed holding seat which extends upwards. The holding seat has a holding trough formed by at least two recesses that correspond to each other in an up and down manner. The holding trough can hold the axle of a pulley. The structure is easy to install and may be fabricated at a low cost.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional pulley dock.

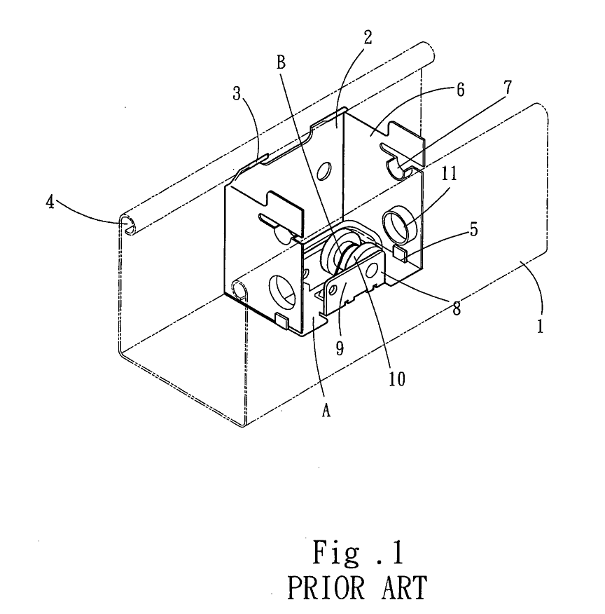

FIG. 2 is an exploded view of an embodiment of the invention.

FIG. 3A is a perspective view of an embodiment of the invention.

FIG. 3B is a cross section taken on line 3B-3B in FIG. 3A.

### DETAILED DESCRIPTION OF THE PREFERRED EMBODIMENT

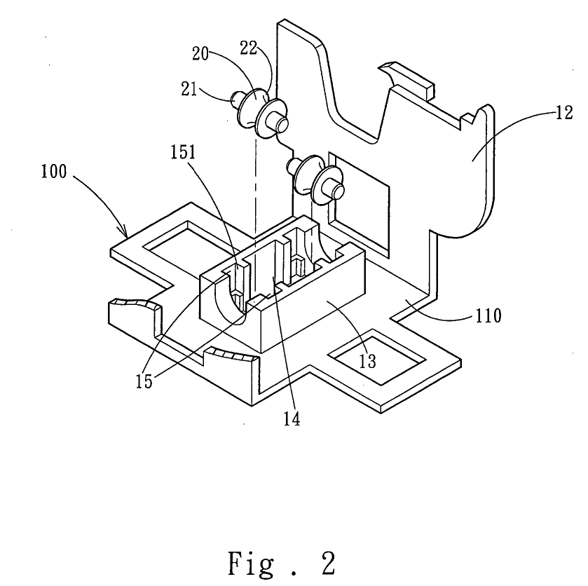

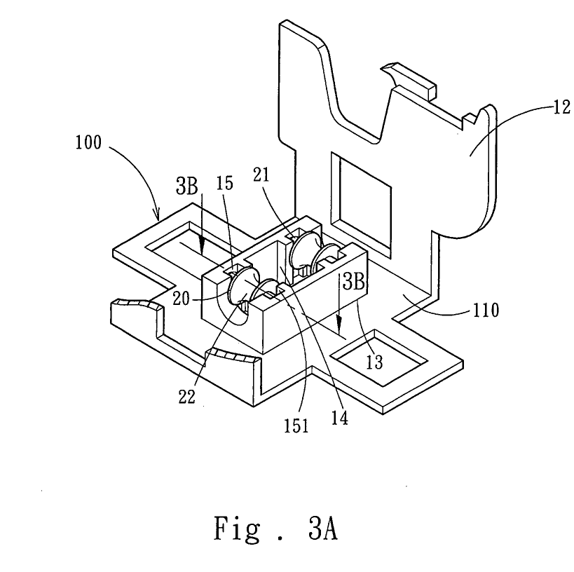

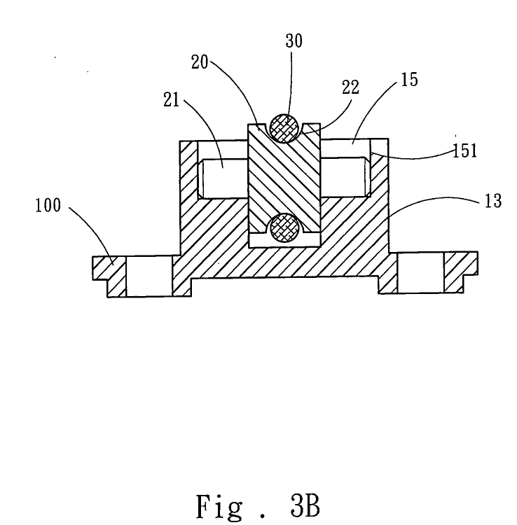

Please refer to FIGS. 2, 3A and 3B for an embodiment of the invention.

The pulley anchor dock for a shutter cord according to the invention is made from plastics in an integrated manner. It includes a U-shaped dock 100. The dock 100 has a bottom plate 110 and a side plate 12 located respectively on the left and right sides. There is a closed fort-like holding seat 13 located in the center of the bottom plate 110 and extended upwards. The holding seat 13 has an elongated recess 14 formed longitudinally in the center with a width to house a sheave 20. The length of the recess 14 can hold two sheaves 20. The upper side and lower side of the recess 14 are extended outwards to form three corresponding interdental spaces to form two holding troughs 15. The two holding troughs 15 on the upper side and the lower side correspond to each other and are aligned to enable the axle 21 of the sheave 20 to straddle thereon. Each holding trough 15 has a front and a rear wall 151 to confine the axle 21 so that the sheave 20 may be held and anchored in the holding trough 15.

For assembly, a sheave 20 is straddled on the holding troughs 15 that correspond to each other. The plastic resilience of the holding seat 13 can directly latch and anchor the axle 21 of the sheave 20. The recess 14 has just enough space to accommodate two sheaves 20. Thereby a shutter cord 30 may be wound around a groove 22 formed between the two sheaves 20.

To summarize, the invention provides an integrated plastic holding seat 13 which has three pairs of corresponding holding troughs 15. The holding troughs 15 have side walls 151 that have an allowance to be extended outwards so that the axle 21 of the sheave 20 may be anchored thereon under compression. The holding troughs 15 in the center provide an extension allowance when the ends of an axle 21 of each sheave 20 are placed in a holding trough at the front side and the rear side. Thus the axle 21 of the sheave 20 may be wedged in the holding troughs 15 easily by force for anchoring.

1. A pulley anchor dock for a shutter cord formed substantially in a U-shaped dock in an integrated manner; the dock comprising a bottom plate and a side plate located respectively on a left side and a right side thereof, the bottom plate holding a closed fort-like holding seat in the center that is extended upwards, the holding seat having at least three interdental spaces corresponding to each other vertically to form a plurality of holding troughs, the corresponding holding troughs forming a recess in-between to house two sheaves, two opposing holding troughs jointly holding a axle of the pulley, the pulley allowing the shutter cord to wind thereon to control lifting and lowering of a shutter.
